(19) United States
(12) Patent Application Publication
(10) Pub. No.: US 2006/0218190 A1
(43) Pub. Date: Sep. 28, 2006

(54) Non-invasive encryption for relational database management systems

(75) Inventors: Stuart Frost, Laguna Niguel, CA (US); David Salch, Chino Hills, CA (US)

Correspondence Address: MCDERMOTT WILL & EMERY LLP, 18191 VON KARMAN AVE., SUITE 500, IRVINE, CA, 92612-7108, US

(73) Assignee: DATALLEGRO, INC., Aliso Viejo, CA (US)

(21) Appl. No.: 11/390,247

(22) Filed: Mar. 28, 2006

Related U.S. Application Data
(60) Provisional application No. 60/665,357, filed on Mar. 28, 2005.

(51) Int. Cl. G06F 17/00

(52) U.S. Cl. 707/104.1

(57) ABSTRACT

A secure relational database system is provided which utilizes a non-invasive encryption technique. Data pages stored or retrieved by a relational database management system are diverted to a multi-channel hardware encryption engine for processing. Each data page is divided into multiple buffers and distributed among the channels of the hardware encryption engine to be processed simultaneously. The data page is then reassembled and passed on to its intended destination.

This application claims the benefit of U.S. Provisional Application No. 60/665,357, filed Mar. 28, 2005, which is incorporated herein by reference.

### BACKGROUND OF THE INVENTION

The invention relates to relational database systems and, in particular, relates to non-invasive data encryption implemented within a relational database system.

Relational databases provide an efficient system for organizing, storing and retrieving large amounts of data. Businesses of all types are continually increasing the amounts and types of data stored within relational databases. In addition, businesses are continually finding new benefits and uses for that data. This drives the demand for database systems having higher performance and increased capabilities.

In many industries, the data being accumulated is confidential and must be securely stored. For example, financial institutions track and store data on transactions executed, account numbers, account balances, account owners, etc. Similarly, the healthcare industry tracks and stores private information concerning an individual's health and treatment history. These industries demand both security and performance from their database systems.

Accordingly, a need exists for a relational database system that is capable of encrypting the data stored therein without requiring extensive modifications to the system's components and without drastically harming the overall performance of the relational database system.

### BRIEF SUMMARY OF THE INVENTION

The invention addresses the foregoing needs and concerns by providing a secure relational database system for encrypting data stored within a relational database. The invention inserts a hardware encryption process into the system without requiring extensive modifications to the individual components of the system. Furthermore, the invention leverages the capabilities of a multi-channel hardware encryption engine to minimize the impact on the performance of the overall system.

According to one aspect of the invention, a method for encrypting data pages stored by a relational database management system in a data storage system is provided. A data page designated for storage is divided into multiple buffers. The buffers are presented to a hardware encryption engine to be encrypted concurrently. Once the hardware encryption engine has completed encryption of the buffers, the data page is reassembled with the encrypted buffers and stored in the data storage system.

According to another aspect of the invention, a secure relational database system for storing data of a relational database in an encrypted form is provided. The system includes a computer server having a processor, a memory and a data storage system. An operating system, for execution by the processor in the computer server, manages the processor, the memory and the data storage system. A relational database management system, for execution by the processor in the computer server, manages a relational database stored in the data storage system. Prior to calling a write function of the operating system to store a data page in the data storage system, the relational database management system divides the data page into multiple buffers and presents the buffers to a hardware encryption engine to be encrypted concurrently. Once the encryption is completed, the hardware encryption engine reassembles the data page with the encrypted buffers.

The foregoing summary of the invention has been provided so that the nature of the invention can be understood quickly. A more detailed and complete understanding of the preferred embodiments of the invention can be obtained by reference to the following detailed description of the invention together with the associated drawings.

### BRIEF DESCRIPTION OF THE DRAWINGS

The following detailed description of the embodiments of the present invention can best be understood when read in conjunction with the following drawings, in which the features are not necessarily drawn to scale but rather are drawn as to best illustrate the pertinent features.

FIG. 1 is a block diagram depicting components of a relational database system.

FIG. 2 is a block diagram depicting components of a secure relational database system according to one embodiment of the invention.

FIG. 3 is a block diagram depicting a computer server system according to one embodiment of the invention.

FIG. 4 is a flowchart illustrating process steps performed to encrypt a data page stored by a relational database management system according to one embodiment of the invention.

FIG. 5 is a block diagram depicting a sequence of processing a data page by an encryption engine according to one embodiment of the invention.

FIG. 6 is a flowchart illustrating process steps performed to decrypt a data page requested by a relational database management system according to one embodiment of the invention.

### DETAILED DESCRIPTION OF THE INVENTION

The invention will now be described more fully with reference to the accompanying drawings, wherein like reference numerals refer to like elements throughout the drawings. The following description includes preferred embodiments of the invention provided to describe the invention by way of example to those skilled in the art.

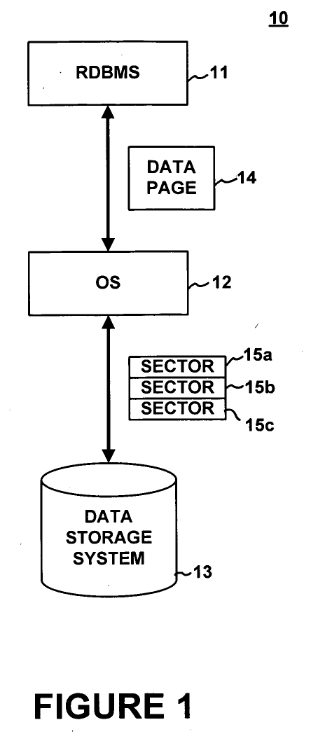

FIG. 1 is a block diagram depicting components of a relational database system 10. As shown in FIG. 1, relational database system 10 includes relational database management system (RDBMS) 11, operating system (OS) 12 and data storage system 13. RDBMS 11 is a computer application, or group of applications, that manages the organization, storage and retrieval of data within a relational database. The relational database is stored in data storage system 13, which includes either a single hard disk drive or an array of hard disk drives configured to store the relational database. OS 12 controls access to data storage system 13 and manages the interface between RDBMS 11 and data storage system 13.

As mentioned above, RDBMS 11 is a computer application for managing a relational database. The invention is not limited to a particular relational database management system and may be implemented using any of a number of systems known to those skilled in the art. Such systems include those offered by Oracle, IBM and Microsoft. Similarly, OS 12 is not limited to a particular operating system and may be implemented using any of a number of operating systems known to those skilled in the art, including Microsoft Windows based operating systems and Unix/Linux based operating systems.

Data storage system 13 was described above as including either a single hard disk drive or an array of hard disk drives. These drives may be arranged as independent volumes or, alternatively, as a redundant array of independent disks (RAID) using any of the RAID configurations known to those skilled in the art. One skilled in the art will also recognize that the drives may be implemented using other storage devices besides hard disk drives. For example, solid-state drives or optical drives may be used in place of hard disk drives.

RDBMS 11 stores data in data storage system 13 in the form of data pages, which are represented by data page 14 in FIG. 1. Each data page contains rows of data from the relational database. Typically, data pages are between 2 kB and 64 kB in size, but may vary depending on the components used to implement the relational database system.

To access the relational database stored in data storage system 13, RDBMS 11 requests the transfer of data page 14 between OS 12 and RDMBS 11. Specifically, to store data in the relational database, RDBMS 11 calls a write routine of OS 12 to store data page 14, which contains the data desired to be stored, in data storage system 13. OS 12 subsequently stores data page 14 in a series of disk sectors, represented by disk sectors 15a, 15b and 15c, in data storage system 13. While only three disk sectors are depicted in FIG. 1, the actual number of disk sectors will vary depending on a number of factors including the type of operating system, the type of data storage system, and the size of the data pages.

To retrieve data from the relational database, RDBMS 11 calls a read routine of OS 12 to retrieve data page 14, which contains the desired data, from data storage system 13. OS 12 retrieves disk sectors 15a, 15b and 15c containing the desired data from data storage system 13 and returns data page 14 containing the desired data to RDBMS 11. Read and write routines used by operating systems are well known to those skilled in the art and therefore will not be discussed in further detail herein.

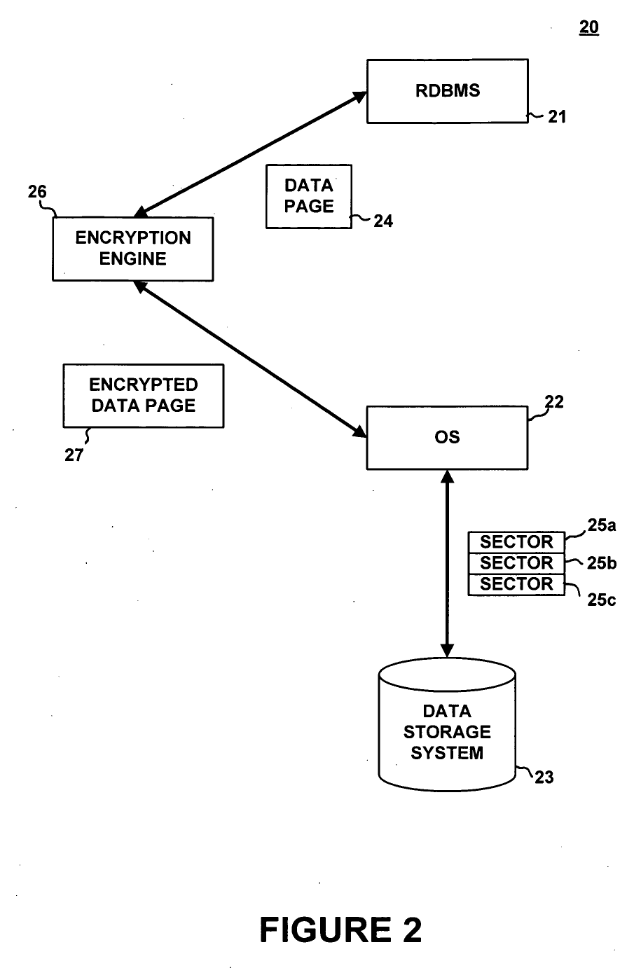

FIG. 2 is a block diagram depicting components of a secure relational database system 20 according to one embodiment of the invention. Similar to the system depicted in FIG. 1, secure relational database system 20 includes a RDBMS 21, an OS 22 and a data storage system 23. As described above, RDBMS 21 is a computer application, or group of applications, that manages the organization, storage and retrieval of data within a relational database. The relational database is stored in data storage system 23, which includes either a single hard disk drive or an array of hard disk drives configured to store the relational database. OS 22 controls access to data storage system 23 and manages the interface between RDBMS 21 and data storage system 23. As with the system depicted in FIG. 1, any of a number of relational database management systems, operating systems and/or data storage systems known to those skilled in the art may be used without departing from the scope of the present invention.

Secure relational database system 20 stores and retrieves data in manner similar to that used by the system depicted in FIG. 1. Specifically, RDBMS 21 sends or requests data page 24, which contains desired data, to or from OS 22. OS 22 subsequently either writes the data contained in data page 24 in a series of disk sectors 25a, 25b and 25c of data storage system 23, or retrieves the desired data stored in the series of disk sectors 25a, 25b and 25c of data storage system 23. However, unlike the system depicted in FIG. 1, secure relational database system 20 inserts encryption engine 26 between RDBMS 21 and OS 22 and diverts data pages to encryption engine 26 before being transferred between RDBMS 21 and OS 22. Encryption engine 26 encrypts/decrypts the data pages before they are passed on to either RDBMS 21 or OS 22. For example, FIG. 2 depicts data page 24 being diverted to encryption engine 26, which encrypts the data contained therein to create encrypted data page 27. Encrypted data page 27 is then stored in disk sectors 25a, 25b and 25c of data storage system 23 by OS 22. A more detailed description of the operation of secure relational database 20 is provided below.

Conventional secure relational database systems typically encrypt the data either inside the RDBMS or before the RDBMS, thereby requiring the RDBMS to operate on encrypted data. Operating on encrypted data limits the functionality and reduces the performance of the RDBMS. The present invention, on the other hand, separates the encryption processing from the RDBMS using a separate encryption engine and performs the encryption processing between the RDBMS and the OS. Accordingly, the internal operations of the RDBMS need not be aware of the encryption processing occurring outside the RDBMS. In this manner, the RDBMS operates on unencrypted data and is able to work at full performance.

According to one embodiment of the invention, encryption engine 26 is a multi-channel hardware encryption engine where each channel is configured to encrypt/decrypt data using an encryption algorithm. Unlike a software encryption engine which relies on a central processor of the system to perform the necessary processing, a hardware encryption engine executes the encryption process using its own internal circuitry. Accordingly, the hardware encryption engine conserves the processor resources of the overall system and minimizes its impact on the overall performance of the system.

A multi-channel hardware encryption engine is utilized in order to allow multiple blocks of data to be processed concurrently. This simultaneous processing of data using the full throughput capabilities of the hardware encryption engine improves the overall performance of the system. Alternatively, multiple single-channel hardware encryption engines could be used without departing from the scope of the invention.

The structure and internal operation of hardware encryption engines are well known to those skilled in the art and will not be described in detail herein. It is noted that the invention may be implemented using any of a number of commercially available hardware encryption engines without departing from the scope of the invention. Furthermore, the invention is not limited to a particular encryption algorithm and may use any of a number of algorithms known to those skilled in the art. For example, algorithms based on the Advanced Encryption Standard (AES) or the Data Encryption Standard (DES, Triple DES) may be used.

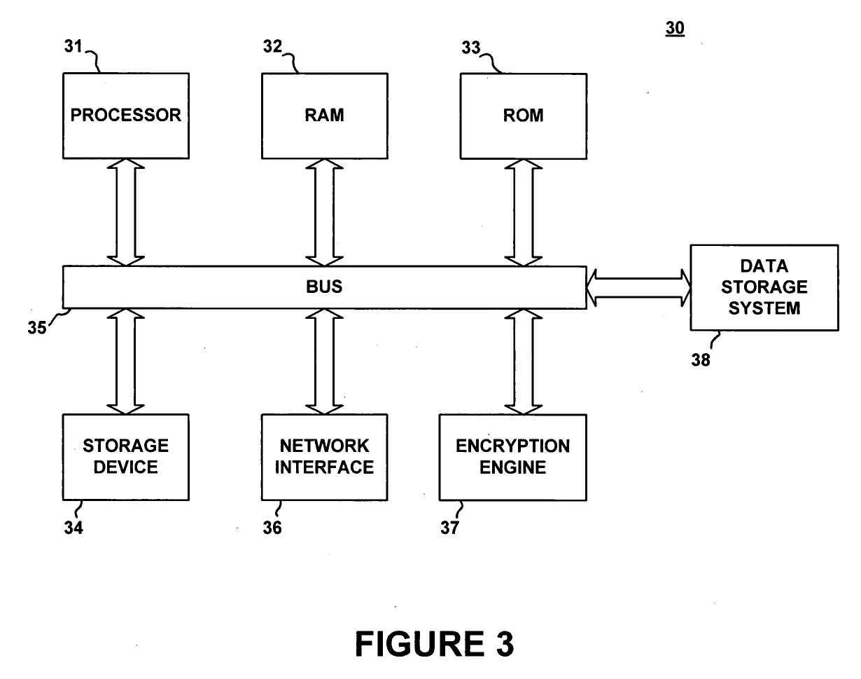

A secure relational database system is implemented using a computer server system according to one embodiment of the invention. FIG. 3 is a block diagram depicting one example of a computer server system 30. Computer server system 30 includes processor 31 for executing instructions and processing information. Random access memory (RAM) 32 temporarily stores information and instructions to be executed by processor 31. Read only memory (ROM) 33 is a non-volatile storage device that stores static instruction sequences such as the basic input/output system (BIOS) executed by processor 31 at start-up to initiate operation of computer server system 30. Storage device 34 represents another non-volatile memory such as a magnetic disk or an optical disk which stores information and instructions to be executed by processor 31. Each of the foregoing components is coupled to bus 35, which facilitates the transfer of information and instructions between the various components.

Also coupled to bus 35 are network interface 36, encryption engine 37 and data storage system 38. Encryption engine 37 and data storage system 38 are described elsewhere in this specification. Network interface 36 is an optional feature which allows computer server system 30 to be interconnected and in communication with other computing devices via one or more networks. Possible networks include local area networks (LANs) and the Internet. Information is transmitted across these networks using electrical, electromagnetic or optical signals. In this manner, computer server system 30 can transmit and/or receive data and code as well as share resources with other devices connected to the same network.

Other devices may be connected to computer server system 30 via bus 35. For example, a display device such as a CRT or a LCD monitor may be connected to display information to a user. In addition, user input devices such as a keyboard and a cursor control device may be connected to computer server system 30 to allow for user input and control in applications executed on computer server system 30.

All of the components of computer server system 30 mentioned above have been described as being part of a single computer system. One skilled in the art will recognize that alternative embodiments of the invention may separate one or more of the components into separate computing systems that are interconnected via one or more networks. For example, data storage system 38 may be located in another system or distributed across multiple systems interconnected by a network without departing from the scope of the invention.

The relational database management system and the operating system used in the present invention are provided by processor 31 executing one or more sequences of instructions stored in RAM 32. These sequences of instructions, or computer code, or loaded into RAM 32 by processor 31 from a computer-readable medium such as storage device 34. Other examples of computer-readable media include, but are not limited to, floppy disks, flexible disks, hard disks, magnetic tape, any other magnetic medium, CD-ROMs, DVD, any other optical medium, physical media such as punch cards and paper tape, RAM, PROM, EPROM, EEPROM, Flash memory, etc. Alternatively, the computer code may be transferred to computer server system 30 over transmission media such as coaxial cables, copper wire or fiber optics. A more detailed description of the operation of the invention is provided below.

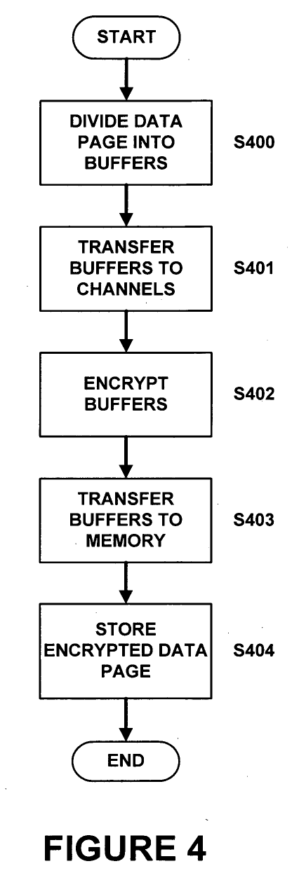

FIG. 4 is a flowchart illustrating a process for encrypting a data page stored by a relational database management system according to one embodiment of the invention. As mentioned above, the present invention diverts data pages that are forwarded by the RDBMS for storage to the encryption engine. The process depicted in FIG. 4 represents the processing associated with the diversion. This process is initiated when the RDBMS has prepared and designated a data page for storage in the relational database. According to one embodiment, the RDBMS is slightly modified to initiate and/or execute the process steps represented in FIG. 4 when calling a write function/routine of the operating system. This process is executed without additional user intervention, thereby making the operation of the invention transparent to the end user of the relational database system. In an alternative embodiment, a software proxy routine is used to replace the standard operating system calls for writing data to the data storage system. The software proxy routine initiates and/or executes the process steps represented in FIG. 4 whenever a call to the operating system write function/routine is made. Software proxy routines are well known to those skilled in the art and therefore will not be described in further detail herein.

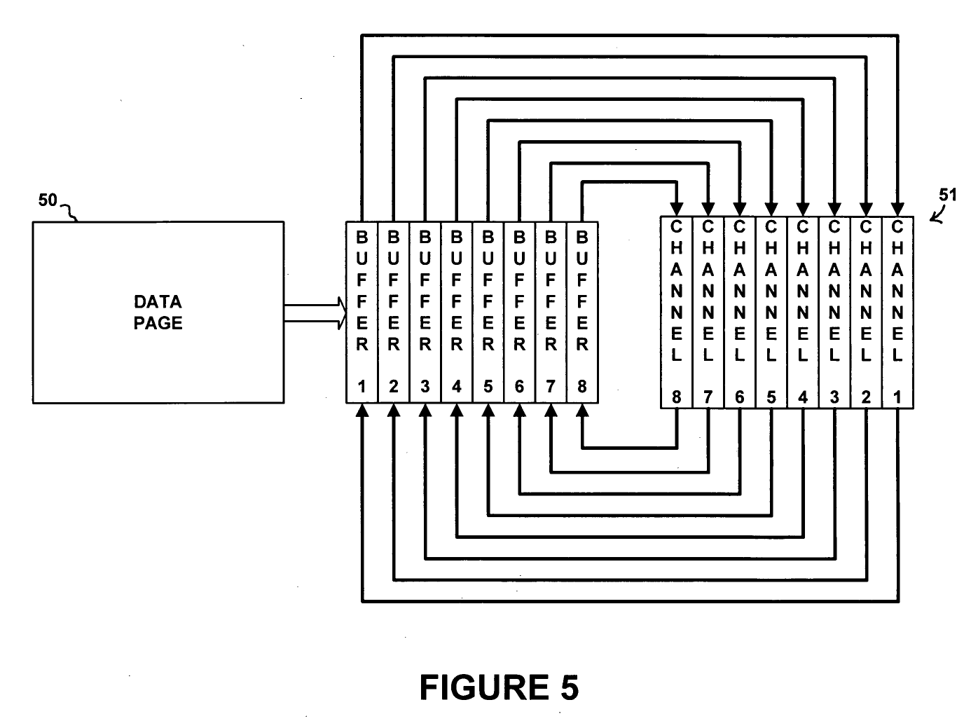

In step S400, the data page is divided into multiple buffers. The number and size of the buffers are determined based on the number of channels in the encryption engine. For example, FIG. 5 is a block diagram depicting the processing of data page 50 using encryption engine 51. As shown in FIG. 5, encryption engine 51 includes eight channels (channel 1 to channel 8). Accordingly, data page 50 is divided into eight buffers (buffer 1 to buffer 8). The number of buffers is preferably selected to be equal to the number of channels in the encryption engine in order to use the full processing capacity of the encryption engine. All of the buffers are preferably equally sized to evenly distribute the data among the channels for processing. For example a 64 kB data page is divided into eight buffers having 8 kB of data each.

Once the RDBMS has prepared and designated a data page for storage, the data page resides in the main memory (RAM) of the computer server system. According to one embodiment of the invention, the data page is divided into multiple buffers by determining a memory address in the main memory for the portions of the data page corresponding to each of the multiple buffers. Accordingly, the division of the data page does not entail a data transfer to actual memory buffers. However, alternative embodiments of the invention may divide and transfer the data page into actual memory buffers.

In step S401, the buffers are transferred to respective channels of the encryption engine. The transfer is performed in two steps. First, all of the buffers are presented simultaneously to the encryption engine as independent jobs to be processed by the channels. The buffers are presented by providing a pointer to the memory address of each of the buffers in main memory. Second, the encryption engine transfers the buffers to their respective channels. Using the pointers together with the size of the buffer, the encryption engine uses Direct Memory Access (DMA) methods known to those skilled in the art to transfer the buffers to their respective channels for processing. This transfer is represented in FIG. 5 by the group of arrows going from buffers 1 to 8 to channels 1 to 8.

According to one embodiment of the invention, the division of the data page into buffers and presentation of the buffers to the channels of the encryption engine are managed by a software driver of the hardware encryption engine. The driver is called by the modified RDBMS when a data page is ready for storage. Alternatively, the RDMBS may be modified to perform the division and presentation of the buffers to the channels.

In step S402, the data in each of the buffers is encrypted by the respective channels of the encryption engine using an encryption algorithm. Because the buffers are presented to the encryption engine simultaneously and each buffer is sized equally, the encryption of each of the buffers is performed in a substantially identical amount of time and therefore all of the buffers complete the encryption processing simultaneously. This concurrent processing of the buffers using all of the channels of the encryption engine allows the maximum throughput of the encryption engine to be achieved for a single database operation of storing a data page.

Once the encryption of the buffers has been completed, the buffers containing the encrypted data are transferred back into main memory in step S403 by the encryption engine using DMA methods known to those skilled in the art. The encrypted buffers are transferred back to main memory using the same pointers previously presented to the encryption engine. This transfer is represented in FIG. 5 by the group of arrows going from channels 1 to 8 to buffers 1 to 8. Accordingly, the data in the data page stored in main memory is effectively overwritten with encrypted data thereby replacing the data page with the encrypted data page. In this manner, the encryption engine reassembles the data page in main memory using encrypted data. Once the encryption engine provides notification that the transfer of encrypted data is complete, the operating system write function is called in step S404 to store the encrypted data page in the data storage system.

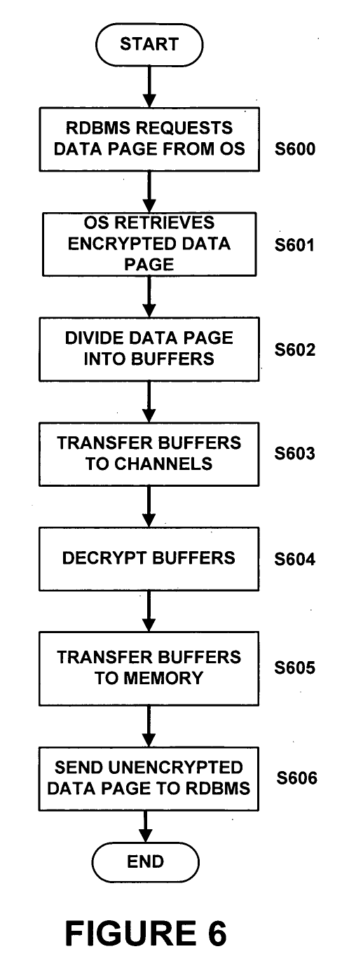

FIG. 6 is a flowchart illustrating a process for decrypting encrypted data pages requested by a relational database management system according to one embodiment of the invention. This process is initiated when the RDBMS has requested a data page to be retrieved from the data storage system. Similar to the process described above with respect to FIG. 4, the RDBMS is slightly modified to initiate and/or execute the process steps represented in FIG. 6 when calling the read function of the operating system to retrieve data stored in the data storage system. In an alternative embodiment, a software proxy routine is used to replace the standard operating system calls for reading data from the data storage system. The software proxy routine initiates and/or executes the process steps represented in FIG. 6 whenever a call to the operating system read function is made. Software proxy routines are well known to those skilled in the art and therefore will not be described in further detail.

In step S600, the desired data page is requested from the data storage system by the RDBMS using the operating system read function. In step S601, the data page, containing encrypted data, is retrieved from the data storage system by the OS and stored in the main memory (RAM) of the computer server system. In the same manner as described above with reference to FIG. 4, the encrypted data page is divided into multiple buffers in step S602 and transferred to respective channels in step S603. The encrypted buffers are then decrypted in step S604.

As with the process described with reference to FIG. 4, the buffers are presented to the respective channels of the encryption engine simultaneously, with each buffer being equally sized. Accordingly, the decryption of each of the buffers is performed in a substantially identical amount of time with all of the buffers completing the decryption processing simultaneously. Once the decryption has been completed, the encryption engine transfers the decrypted data in step S605 into the main memory in the same manner as described above with respect to FIG. 4. This process reassembles the data page using unencrypted buffers by overwriting the encrypted buffers in the main memory. Finally, in step S606, the requested data page containing unencrypted data is sent to the RDBMS.

The invention described above provides non-invasive encryption to a relational database system. By slightly modifying the RDBMS, or using software proxy routines, the encryption of data stored in a relational database is achieved in a manner transparent to the user. The impact on the overall performance of the relational database system is minimized by using a hardware encryption engine having multiple channels and distributing each data page across the channels for processing.

In an alternative embodiment, a multi-channel hardware compression engine is added to the hardware encryption engine to compress the data pages prior to storage in the data storage system and decompress the data pages after retrieval from the data storage system. Any of a number of known compression algorithms may be used without departing from the scope of the invention. The operation of the hardware compression engine with respect to the data pages is the same as that described above for the hardware encryption engine, with the addition of including a utility to track the number and location of the disk sectors in the data storage system used to store the compressed data pages. This tracking is necessary since the compression will generally change the number of sectors required to store each data page and therefore also the location of the data pages within the data storage system. The implementation of such a tracking utility will be apparent to one skilled in the art and therefore will not be described in additional detail herein.

The invention has been described above as processing an entire data page upon storage or retrieval of the data page. In an alternative embodiment, the hardware encryption engine is configured to only encrypt/decrypt text fields within the data page. The hardware encryption engine may also be configured to only process specified columns within the data page. In this manner, the encryption system can be fine tuned to encrypt only the sensitive data while leaving the remainder of the data within a data page in unencrypted form.

The foregoing description of the invention describes the diversion of data as occurring between the relational database management system and the operating system. In alternative embodiments of the invention, the system may be configured to divert the data between the operating system cache and the file system, between the file system and the disk controller, between page and row handling within the RDBMS, or between the row and column handling within the RDBMS. One skilled in the art will recognize how to shift the diversion of the present invention to any of the foregoing positions.

The foregoing description of the invention illustrates and describes the preferred embodiments of the present invention. However, it is to be understood that the invention is capable of use in various other combinations and modifications within the scope of the inventive concept as expressed herein, commensurate with the above teachings, and/or the skill or knowledge of the relevant art. The embodiments described hereinabove are further intended to explain best modes known of practicing the invention and to enable others skilled in the art to utilize the invention in such, or other, embodiments and with the various modifications required by the particular applications or uses of the invention. Accordingly, the description is not intended to limit the scope of the invention, which should be interpreted using the appended claims.

The invention claimed is:

1. A method for encrypting data pages stored by a relational database management system in a data storage system, the method comprising the steps of:
dividing a data page designated for storage into a plurality of buffers;
presenting the plurality of buffers to a hardware encryption engine to be encrypted concurrently;
storing the data page in a data storage system after the hardware encryption engine has completed encryption of the plurality of buffers,
wherein the hardware encryption engine reassembles the data page with the plurality of encrypted buffers.

2. The method according to claim 1, wherein the plurality of buffers are sized equally.

3. The method according to claim 1, wherein the hardware encryption engine comprises a plurality of channels and each of the plurality of buffers is presented to a respective one of the plurality of channels.

4. The method according to claim 3, wherein the number of buffers equals the number of channels.

5. The method according to claim 1, wherein the dividing step comprises determining a memory address within the data page for each of the plurality of buffers, and
wherein the presenting step comprises presenting a pointer to the memory address of each of the plurality of buffers to the hardware encryption engine.

6. The method according to claim 1, further comprising the step of presenting the plurality of buffers to a hardware compression engine to be compressed concurrently,
wherein the data page is stored after the hardware compression engine has completed compression of the plurality of buffers.

7. A secure relational database system for storing data of a relational database in an encrypted form, the system comprising:
a computer server having a processor, a memory and a data storage system;
an operating system, for execution by the processor in the computer server, for managing the processor, the memory and the data storage system of the computer server;
a hardware encryption engine;
a relational database management system, for execution by the processor in the computer server, for managing a relational database stored in the data storage system;
means for diverting a data page written by the relational database management system to the operating system for storage in the data storage system to the hardware encryption engine to be encrypted prior to storing the data page in the data storage system; and
means for diverting a data page read by the relational database management system from the data storage system to the hardware encryption engine to be decrypted prior to the relational database management system receiving the data page.

8. The secure relational database system according to claim 7, further comprising means for dividing the data page written by the relational database management system into a plurality of buffers and presenting the plurality of buffers to the hardware encryption engine to be encrypted concurrently,
wherein the hardware encryption engine reassembles the data page with the plurality of encrypted buffers.

9. The secure relational database system according to claim 8, wherein the plurality of buffers are sized equally.

10. The secure relational database system according to claim 8, wherein the hardware encryption engine comprises a plurality of channels and each of the plurality of buffers is presented to a respective one of the plurality of channels.

11. The secure relational database system according to claim 10, wherein the number of buffers equals the number of channels.

12. The secure relational database system according to claim 8, wherein the means for dividing the data page step comprises means for determining a memory address within the data page for each of the plurality of buffers, and
wherein the means for presenting the plurality of buffers to the hardware encryption engine presents a pointer to the memory address of each of the plurality of buffers to the hardware encryption engine.

13. The secure relational database system according to claim 7, further comprising:
a hardware compression engine;
means for diverting the data page written by the relational database management system to the hardware compression engine to be compressed prior to storing the data page in the data storage system; and
means for diverting the data page read by the relational database management system to the hardware compression engine to be decompressed prior to the relational database management system receiving the data page.

14. A secure relational database system for storing data of a relational database in an encrypted form, the system comprising:
a computer server having a processor, a memory and a data storage system;
an operating system, for execution by the processor in the computer server, for managing the processor, the memory and the data storage system;
a hardware encryption engine;
a relational database management system, for execution by the processor in the computer server, for managing a relational database stored in the data storage system,
wherein, prior to calling a write function of the operating system to store a data page in the data storage system, the relational database management system is configured to divide the data page into a plurality of buffers and present the plurality of buffers to the hardware encryption engine to be encrypted concurrently, wherein the hardware encryption engine reassembles the data page with the plurality of encrypted buffers.

15. The secure relational database system according to claim 14, wherein the plurality of buffers are sized equally.

16. The secure relational database system according to claim 14, wherein the hardware encryption engine comprises a plurality of channels and each of the plurality of buffers is presented to a respective one of the plurality of channels.

17. The secure relational database system according to claim 16, wherein the number of buffers equals the number of channels.

18. The secure relational database system according to claim 14, wherein the relational database management system is configured to determine a memory address within the data page for each of the plurality of buffers, and
wherein the relational database management system is configured to present a pointer to the memory address of each of the plurality of buffers to the hardware encryption engine.

19. The secure relational database system according to claim 14, further comprising a hardware compression engine, wherein the relational database management system is configurd to present the plurality of buffers to the hardware compression engine to be compressed concurrently prior to calling the write function of the operating system to store the data page in the data storage system.

20. Computer-executable program code stored on a computer-readable medium, the computer-executable program code for encrypting data pages stored by a relational database management system in a data storage system, the computer-executable program code comprising:
code to divide a data page designated for storage into a plurality of buffers;
code to present the plurality of buffers to a hardware encryption engine to be encrypted concurrently;
code to store the data page in a data storage system after the hardware encryption engine has completed encryption of the plurality of buffers,
wherein the hardware encryption engine reassembles the data page with the plurality of encrypted buffers.

21. The computer-executable program code according to claim 20, wherein the plurality of buffers are sized equally.

22. The computer-executable program code according to claim 20, wherein the hardware encryption engine comprises a plurality of channels and each of the plurality of buffers is presented to a respective one of the plurality of channels.

23. The computer-executable program code according to claim 22, wherein the number of buffers equals the number of channels.

24. The computer-executable program code according to claim 20, wherein the code to divide the data page determines a memory address within the data page for each of the plurality of buffers, and
wherein the code to present the plurality of buffers presents a pointer to the memory address of each of the plurality of buffers to the hardware encryption engine.

25. The computer-executable program code according to claim 20, further comprising code to present the plurality of buffers to a hardware compression engine to be compressed concurrently,
wherein the data page is stored after the hardware compression engine has completed compression of the plurality of buffers.
